(19) United States
(12) Patent Application Publication
(10) Pub. No.: US 2019/0186656 A1
(43) Pub. Date: Jun. 20, 2019

(54) Spiral Hydraulic Hose

(71) Applicant: ContiTech USA, Inc., Fairlawn, OH (US)

(72) Inventors: Robert Kozak, Burlington, IA (US); John Anthony Brookes, Chorley (CN); Ming Cheng, Yanzhou City (CN); Wei Qi, Yanzhou City (CN)

(73) Assignee: ContiTech USA, Inc., Fairlawn (US)

(21) Appl. No.: 16/176,132

(22) Filed: Oct. 31, 2018

(30) Foreign Application Priority Data
Dec. 14, 2017 (CN) 201711337970.0

(51) Int. Cl. F16L 11/08; B29C 53/58; B29C 70/02; B29C 70/22

(52) U.S. Cl. CPC F16L 11/087; B29C 53/58; B29K 2023/083; B29C 70/222; B29K 2023/06; B29C 70/02

(57) ABSTRACT

A hose includes an inner tube, a cover, and at least three reinforcement layers applied between the inner tube and the cover, where two immediately adjacent reinforcement layers of the at least three reinforcement layers are applied in same spiral directions (+) (+), and where another reinforcement layer of the at least three reinforcement layers is applied in an opposing spiral direction (−). The inner tube may have a tube wall thickness (t) of between about 0.5 mm to about 1.5 mm, and the hose may have a wall thickness (T), where the tube wall thickness (t) may be less than about 25% of the hose wall thickness. Optional tie layers may be disposed between the at least three reinforcement layers. The inner tube may include rod shaped particles orientated substantially parallel with the central longitudinal axis of the hose.

### RELATED APPLICATION INFORMATION

This patent application claims priority to Chinese Patent Application No. 201711337970.0 filed Dec. 14, 2017, the disclosure of which is incorporated herein in its entirety, by reference.

### FIELD

The field to which the disclosure generally relates is flexible rubber hoses for low, medium, or, particularly, high pressure hydraulic applications.

### BACKGROUND

This section provides background information to facilitate a better understanding of the various aspects of the disclosure. It should be understood that the statements in this section of this document are to be read in this light, and not as admissions of prior art.

Flexible rubber hose is used in a variety of hydraulic and other fluid transfer applications for conveying fluid pressures which for “high” pressure applications typically range from about 4000 psi (28 MPa) to 8000 psi (55 MPa) or more. In basic construction, hoses of the type herein involved typically are formed as having a tubular, inner tube or core surrounded by one or more outer layers of a braided or spiral-wound reinforcement material which may be a metal or metal-alloy wire or a natural or synthetic fiber. The reinforcement layers, in turn, are protected by a surrounding outermost jacket or cover which may be of the same or different material as the inner tube. The cover also provides the hose with increased abrasion resistance.

In the case of “rubber,” as opposed to thermoplastic, hose constructions, the inner tube, may be provided as formed of a vulcanizable natural or, more typically, a synthetic rubber material such as Buna-N or neoprene. Such material or blend may be conventionally extruded and cooled or cured to form the inner tube. In some cases, the tube may be cross-head extruded over a mandrel for support, or otherwise supported in later forming operations using air pressure and/or reduced processing temperatures.

From the extruder, the inner tube may be delivered through a braider and/or a spiral winder for its reinforcement with one or more surrounding layers of a wire and/or fibrous material or blend such as a monofilament, yarn, cord, yarn-wire composite, or roving. Such reinforcement layers are often applied under tension and typically may be formed of an interwoven braid or a spiral winding of a nylon, polyester, polyphenylene bezobisoxazole, polyvinyl acetate, or aramid yarn, or a high tensile steel or other metal wire. A relatively thin bonding or other interlayer of a vulcanizable rubber may be extruded or otherwise applied between each of the reinforcement layers to bond each layer to the next layer.

Following the braiding, winding, or other application of the reinforcement layers and the interlayers, an outer cover or sheath optionally may be applied. Such cover, which may be formed as a cross-head extrusion, a moisture-cured or solvent-based dipped coating, or a spiral-wound wrapping, typically comprises an abrasion-resistant synthetic rubber or a thermoplastic such as a polyurethane. Following the application of the cover, the hose construction so-formed by be heated to vulcanize the rubber layers and thereby consolidate the construction into an integral hose structure.

In normal use, such as in mobile or industrial hydraulic applications, hoses of the type herein involved may be exposed to a variety of environmental factors and mechanical stresses which cannot always be predicted. Of utmost importance to the integrity and performance of the hose is that a strong bond is achieved between the constituent parts thereof. However, while it is important to bond these parts together, it is also important that the hose not be made overly stiff so as to make it prone to kinking or fatigue or otherwise useable for certain applications.

Current spiral hose designs use multiple layers of materials. The hose typically starts with a rubber inner tube, and a layer of textile braid or leno fabric covers the tube which prevents ends of wire from penetrating the tube during the spiral process. A rubber tie gum covers the textile braid or leno fabric to develop adhesion between the tube and the first layer of wire, and multiple layers of wire are spirally wound around the hose, with rubber friction layers applied between each layer of wire. The wire layers are applied in alternating spiral directions. In other words, the first layer of wire reinforcement layer is applied in one spiral direction, then the next layer is applied in the opposing spiral direction, the next again in the same spiral direction as the first layer, and so on. The layers are applied is sets of two each and usually separated by a layer of rubber.

Finally the hose is covered by an outer layer of weather and abrasion resistant rubber. Hence, a conventional inner tube compound requires a textile braid or leno fabric to protect the soft uncured tube during the wire spiraling process. The textile braid or leno fabric prevents an end of wire from penetrating into the green tube during the spiral wire process. This protective layer is an expensive added cost and process to manufacture such hoses.

A problem with this design and method of manufacture is such hoses are too rigid and large in size. The industry seeks hydraulic hoses that are more flexible, more compact, have a smaller bend radius so the hose can be put into more compact environment, and reduced costs by using shorter lengths. Such needs are met, at least in part, by embodiments according to this disclosure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In a first aspect of the disclosure, hose embodiments include an inner tube defining a central longitudinal axis there through, and which is formed of vulcanized rubber, where the inner tube has a tube wall thickness (t) of between about 0.5 mm to about 1.5 mm. A first reinforcement layer is applied adjacent the inner tube in a spiral direction (+) at pitch angle θ, and a second reinforcement layer is applied in the same spiral direction (+), at pitch angle θ′. A third reinforcement layer is applied adjacent the second reinforcement layer, and the third reinforcement layer is applied in an opposing spiral direction (−) at pitch angle −θ. A cover disposed outward from the third reinforcement layer. In some aspects, the hose has a wall thickness (T), and the tube wall thickness (t) comprises less than about 25% of the hose wall thickness.

The vulcanized rubber may be an acrylonitrile butadiene rubber (NBR), a hydrogenated NBR (HNBR), a cross-linked NBR (XNBR), or copolymers and blends thereof. The inner tube may include a plurality of rod shaped particles orientated substantially parallel with the central longitudinal axis of the hose, and the plurality of rod shaped particles may be incorporated in an amount of 10% or less by weight, based upon total weight of the inner tube. In some cases, the plurality of rod shaped particles is incorporated in an amount of from 1% to 7% by weight, based upon total weight of the inner tube.

In some embodiments, a tie layer is disposed between the first reinforcement layer and the second reinforcement layer, and/or disposed between the second reinforcement layer and the third reinforcement layer.

In some embodiments a fourth reinforcement layer is applied adjacent third reinforcement layer, where the fourth reinforcement layer is applied in an opposing spiral direction (−), at pitch angle −θ′, or applied in a like spiral direction (+), at pitch angle θ″.

In another aspect of the disclosure, a hose includes an inner tube, a cover, and at least three reinforcement layers applied between the inner tube and the cover, where two immediately adjacent reinforcement layers of the at least three reinforcement layers are applied in same spiral directions (+) (+), and where another reinforcement layer of the at least three reinforcement layers is applied in an opposing spiral direction (−). The inner tube may have a tube wall thickness (t) of between about 0.5 mm to about 1.5 mm, and the hose may have a wall thickness (T), where the tube wall thickness (t) may be less than about 25% of the hose wall thickness. Optional tie layers may be disposed between the at least three reinforcement layers.

In some cases, the inner tube includes a plurality of rod shaped particles orientated substantially parallel with the central longitudinal axis of the hose. The plurality of rod shaped particles may be incorporated in an amount of 10% or less by weight, based upon total weight of the inner tube.

In yet another aspect of the disclosure, hose embodiments include an inner tube defining a central longitudinal axis there through, and formed from a vulcanized rubber. A first reinforcement layer is applied adjacent inner tube in a spiral direction (+) at pitch angle θ, a second reinforcement layer is applied in the same spiral direction (+) at pitch angle θ′, and a third reinforcement layer is applied in the same spiral direction (+) at pitch angle θ″. A fourth reinforcement layer is applied in an opposing spiral direction (−) at pitch angle −θ, and a fifth reinforcement layer is applied in the spiral direction (−) at pitch angle −θ′. A cover is disposed outward from the fifth reinforcement layer.

In some aspects, optional tie layers are disposed between the first reinforcement layer and the second reinforcement layer, between the second reinforcement layer and the third reinforcement layer, between the third reinforcement layer and the fourth reinforcement layer, and/or between the fourth reinforcement layer and the fifth reinforcement layer.

In some cases, the inner tube has a tube wall thickness (t) of between about 0.5 mm to about 1.5 mm. The hose may have a wall thickness (T), and the tube wall thickness (t) comprises less than about 25% of the hose wall thickness. Also, the inner tube may include a plurality of rod shaped particles orientated substantially parallel with the central longitudinal axis, and the plurality of rod shaped particles may be incorporated in an amount of 10% or less by weight, based upon total weight of the inner tube.

In some aspects, the fourth reinforcement layer and the fifth reinforcement layer have a combined tensile strength value which substantially equal to a combined tensile strength of the first reinforcement layer, the second reinforcement layer and the third reinforcement layer.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 illustrates in perspective view, a prior art hose, and FIG. 2 depicts in a cross sectional view, the hose illustrated in FIG. 1;

FIGS. 3 through 10, illustrate in perspective views, some hose embodiments according to aspects of the disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount or value range listed or described as being useful, suitable, or the like, is intended that any and every concentration or amount or value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

For illustration purposes, the precepts of the compact rubber hose construction herein involved are described in connection with a configuration as particularly adapted for use in high pressure, i.e., between about 4000-8000 psi (28-55 MPa) mobile or industrial hydraulic applications. It will be appreciated, however, that aspects of the present disclosure may find use in other hose constructions for a variety or general hydraulic or other fluid transfer applications. Use within those such other applications therefore should be considered to be expressly within the scope of this disclosure.

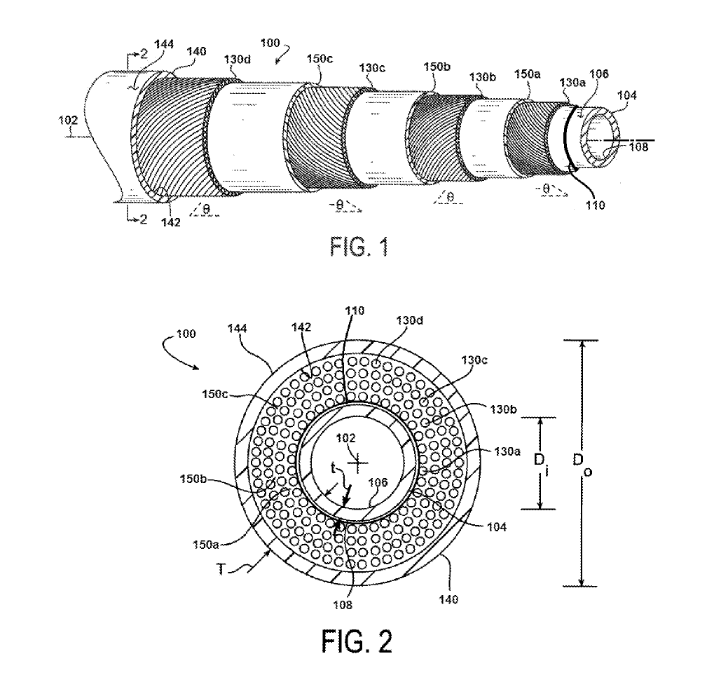

Referring now to the figures wherein corresponding reference characters are used to designate corresponding elements throughout the several views with equivalent elements being referenced with prime or sequential alphanumeric designations, a representative conventional, prior art, hose construction is shown generally at 100 in the cut-away view of FIG. 1 and in the radial cross-sectional view of FIG. 2. In basic dimensions, hose 100 extends axially to an indefinite length along a central longitudinal axis 102, and has a select inner and outer diameter referenced, respectively, at “Di” and “Do” in the radial cross-sectional view of FIG. 2. The inner and outer diameter dimensions may vary depending upon the particular fluid conveying application involved, but generally for many high pressure hydraulic applications will be between about 0.25-2 inch (6-51 mm) for inner diameter Di, and about 0.5-3 inch (13-76 mm) for outer diameter Do, with an overall wall thickness, “T,” there between of from about 0.12 to about 0.5 inch (3-13 mm).

As may be seen in the different views of FIGS. 1 and 2, hose 100 is constructed as being formed about a tubular inner layer, i.e., inner tube or core, 104, which may be of a single or multi-layer construction, and generally includes a vulcanized rubber. In either construction, inner tube 104 has a circumferential outer core tube surface, 106, and a circumferential inner core tube surface, 108, which defines the inner diameter Di of the hose 100. A wall thickness is defined between the outer and inner core tube surfaces 106 and 108, as referenced at “t” in the cross-sectional view of FIG. 2. Such thickness t, which may be between about 0.02-0.05 inch (0.5-1.25 mm), may be the minimum necessary to provide the desired pressure rating and solvent, gas, and/or liquid permeation resistance. With the overall wall thickness T of hose 100 being, as mentioned, between about 0.12-0.5 inch (3-13 mm) for many sizes of hose 100, the tube wall thickness t thus may comprises less than about 25% of that thickness T, with the balance being comprised of the reinforcement and bonding layers, and any cover, that are necessary for the hose to meet a size, desired pressure rating, and/or applicable industrial standard. Disposed over inner tube 104 is tie layer 110 surrounding the inner tube 104. The materials used in the composition of inner tube 104 resists repeated high pressure impulse cycles and securely seals against a fitting, even though the tube wall gauge is thin. Furthermore, in manufacturing, it may be desirable to use a textile braid or leno fabric disposed over the outer surface 106 of the inner tube 104.

In an aspect of the disclosure, carbon rod shaped particles are mixed with the inner tube compound so as to effectively increase green strength and allow spiral wire processing without the use of a protective layer of textile braid or leno fabric. When the inner tube compound is extruded into the shape of the tube, the rod shaped particles at least substantially align longitudinally along the length (i.e. central longitudinal axis) of the tube. This produces very high tensile and modulus properties in the extruded direction, which is along the central longitudinal axis. These properties reduce tube deformation under high pressure impulse cycles which prevents pinholes in the tube and extends the life of the hose. The high longitudinal strength also better holds the fitting onto the end of the hose for longer assembly life.

Referring again to FIGS. 1 and 2, as may be seen in the different views, hose 100 is constructed as being formed about a tubular inner layer, i.e., inner tube or core, 104, which may be of a single or multi-layer construction. In either construction, inner tube 104 has a circumferential outer core tube surface, 106, and a circumferential inner core tube surface, 108, which defines the inner diameter Di of the hose 100. A wall thickness is defined between the outer and inner core tube surfaces 106 and 108, as referenced at “t” in the cross-sectional view of FIG. 2. Such thickness t, which may be between about 0.02-0.05 inch (0.5-1.25 mm), may be the minimum necessary to provide the desired pressure rating and solvent, gas, and/or liquid permeation resistance. With the overall wall thickness T of hose 100 being, as mentioned, between about 0.12-0.5 inch (3-13 mm) for many sizes of hose 100, the tube wall thickness t thus may comprises less than about 25% of that thickness T, with the balance being comprised of the reinforcement and bonding layers, and any cover, that are necessary for the hose to meet a size, desired pressure rating, and/or applicable industrial standard.

With respect to the spiral-wound construction shown in FIGS. 1 and 2, at least two, and typically four (as shown) or up to six or more, reinforcement layers, 130a-d, are provided over the inner tube 104. Each of the reinforcement layers 130 may be conventionally formed as braided, knitted, wrapped, or, as is shown, spiral, i.e., helically, wound of, for example, from 1 to about 180 ends of monofilament, continuous multi-filament, i.e., yarn, stranded, cord, roving, thread, tape, or ply, or short “staple” strands of a fiber material. The fiber material, which may be the same or different in layers 130a-d, may be a natural or synthetic polymeric material such as a nylon, cotton, polyester, polyamide, aramid, polyolefin, polyvinyl alcohol (PVA), polyvinyl acetate, or polyphenylene bezobisoxazole (PBO), or blend, a steel, which may be stainless or galvanized, brass, zinc or zinc-plated, or other metal wire, or a blend thereof.

In the illustrated spiral wound construction of FIGS. 1 and 2, which also may contain additional extruded, spiral, braided, and/or knitted layers (not shown), the reinforcement layers 130a-d are oppositely wound in pairs so as to counterbalance torsional twisting effects. For each of the spiral wound layers 130a-d, from 1 to about 180 parallel ends of, preferably, a monofilament metal or metal alloy wire, may be helically wound under tension in one direction, i.e., either left or right hand, with the next immediately succeeding layer 130 being wound in the opposite direction. The inner reinforcement layer 130a may be wound as is shown in FIG. 1 directly over the outer surface 106 of inner tube 104, or over an intermediate textile, foil, film, tie layer, or other layer.

As successively wound in the hose 100, the layers 130a-d each may have a predetermined pitched angle, referenced at −θ in FIG. 1 for layers 130a and 130c, and at for layers 130b and 130d, measured relative to the longitudinal axis 12 of the hose 100. For typical applications, the pitch angle θ will be selected to be between about 45-65°, but particularly may be selected depending upon the desired convergence of strength, elongation, weight, and volumetric expansion characteristics of hose 100. In general, higher pitch angles above about 54.7° exhibit decreased radial expansion of the hose under pressure, but increased axial elongation. For high pressure applications, a “neutral” pitch angle of about 54.7° generally is preferred as minimizing elongation to about ±3% of the original hose length. Each of the layers 130 may be wound at the same or different absolute pitch angle, and it is known that the pitch angles of respective reinforcement layers may be varied to affect the physical properties of the hose. In a preferred construction, however, the pitch angles of reinforcement layers 130a-d are provided to about the same, but as reversed in successive layers.

The outermost reinforcement layer 130d may be sheathed within one or more layers of a coaxially-surrounding protective cover or jacket, referenced at 140, having a circumferential interior surface, 142, and an opposing circumferential exterior surface, 144, which defines the hose outer diameter Do. Depending upon its construction, cover 140 may be spray-applied, dip coated, cross-head or co-extruded, or otherwise conventionally extruded, spiral or longitudinally, i.e., “cigarette,” wrapped, or braided over the reinforcement layer 130d,

Each of the reinforcement layers 130a-d within hose 100 may be bonded, such as chemically and/or mechanically, to its immediately succeeding layer 130 so as to provide for the more efficient transfer of induced internal or external stresses. Such bonding may be effected via the provision of a bonding agent in the form of an intermediate adhesive, resin, or other interlayer, 150a-c. In an illustrative embodiment, such bonding agent may be provided as an adhesive in the form of a melt-processible or vulcanizable material which is extruded or otherwise applied in a molten, softened, uncured or partially uncured, or otherwise flowable phase over each of the reinforcement layers 130a-d to form the respective interlayers 150a-c. Each such interlayer 150 may have a thickness of between about 1-25 mils (0.025-0.64 mm). The corresponding reinforcement layer 130 then may be wound over the corresponding interlayer 150 while it is still in its softened phase. Alternatively in the case of a thermoplastic interlayer 150, the layer may be reheated to effect its re-softening prior to the winding of reinforcement layer 130.

The material forming interlayers 150 specifically may be selected for high or low temperature performance, flexibility, or otherwise for compatibility with the reinforcement layers 130 and/or the inner tube 104 and cover 140. Suitable materials include natural and synthetic rubbers, as well as thermoplastic, i.e., melt-processible, or thermosetting, i.e., vulcanizable, resins which should be understood to also include, broadly, materials which may be classified as elastomers or hot-melts. Representative of such resins include plasticized or unplasticized polyamides such as nylon 6, 66, 11 and 12, polyesters, copolyesters, ethylene vinyl acetates, ethylene terpolymers, polybutylene or polyethylene terephthalates, polyvinyl chlorides, polyolefins, fluoropolymers, thermoplastic elastomers, engineering thermoplastic vulcanizates, thermoplastic hot-melts, copolymer rubbers, blends such as ethylene or propylene-EPDM, EPR, or NBR, polyurethanes, and silicones. In the case of thermoplastic resins, such resins typically will exhibit softening or melting points, i.e., Vicat temperatures, of between about 77-250° C. For amorphous or other thermoplastic resins not having a clearly defined melting peak, the term melting point also is used interchangeably with glass transition point.

With each of the respective layers 104, optional tie layer 110, 130a, 150a, 130b, 150b, 130c, 150c, 130d, and 140 being extruded, wound, or otherwise formed sequentially in such order, following the application of the cover 140, the hose 100 may be heated to vulcanize the rubber layers and thereby consolidate the construction into an integral hose structure.

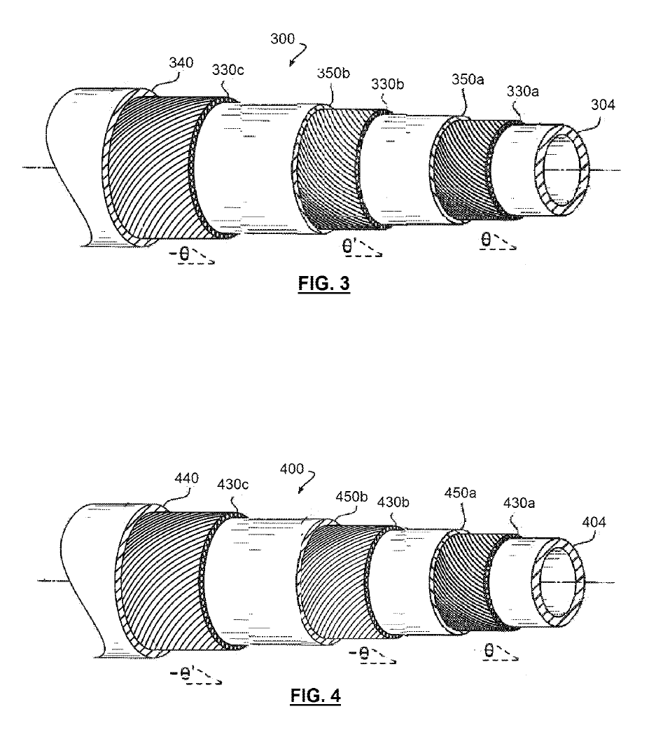

All of the aspects, characteristics, dimensions and materials described above for conventional prior art hydraulic hoses may be useful, or otherwise applied to the inventive hoses according to the disclosure. However, in contrast to the conventional prior art hydraulic hoses, hydraulic hoses according to the disclosure have at least two adjacent reinforcement layers applied in the same spiral direction, and at least another reinforcement layer applied in an opposing spiral direction. Thus, in a hose having three reinforcement layers, two adjacent layers are applied in a like spiral direction, while the third is applied in the opposing spiral direction. This concept is depicted in FIGS. 3 and 4.

With reference to FIG. 3, hose 300 includes an inner tube (or core) 304 which may be of a single or multi-layer construction, and generally includes a vulcanized rubber. A first reinforcement layer 330a is applied adjacent inner tube 304 in a spiral direction (+) with pitch angle θ, and a second reinforcement layer 330b is applied in the same spiral direction (+), at pitch angle θ′. For purposes of the disclosure, reinforcement layers next to one another, such as first reinforcement layer 330a and second reinforcement layer 330b, are considered immediately adjacent reinforcement layers. Pitch angle θ and pitch angle θ′ may or may not be equivalent angles, which is generally the case for any of the reinforcement layers used in the hose embodiments. An optional tie layer 350a may be disposed between reinforcement layer 330a and reinforcement layer 330b. A third reinforcement layer 330c is disposed adjacent second reinforcement layer 330b, which is applied in the opposing spiral direction (−), at pitch angle −θ. An optional tie layer 350b may be disposed between reinforcement layer 330b and reinforcement layer 330c. Hose 300 further includes cover layer 340 as the outermost layer of hose 300. Thus, hose 300 is provided which is of a (+) (+) (−) multiple reinforcement layer spiral direction configuration, from innermost reinforcement layer to outermost.

Now referencing FIG. 4, hose 400 includes inner tube 404 and a first reinforcement layer 430a applied adjacent inner tube 404 in a spiral direction (+) with pitch angle θ. A second reinforcement layer 430b is applied in the opposing spiral direction (−), at pitch angle −θ. An optional tie layer 450a may be disposed between reinforcement layer 430a and reinforcement layer 430b. A third reinforcement layer 430c is disposed adjacent second reinforcement layer 430b, and is applied in the same spiral direction (−), at pitch angle −θ′. An optional tie layer 450b may be disposed between reinforcement layer 430b and reinforcement layer 430c. Hose 400 further includes cover layer 440 as the outermost layer. As such, hose 400 is provided which is of a (+) (−) (−) multiple reinforcement layer spiral direction configuration.

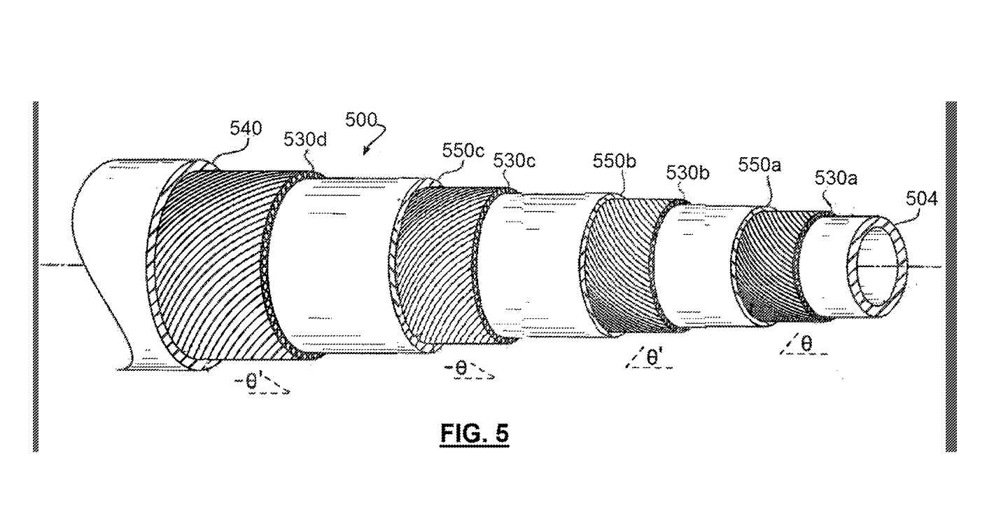

With reference to FIG. 5, which depicts yet another hose embodiment according to the disclosure. Hose 500 includes inner tube 504 and a first reinforcement layer 530a applied adjacent inner tube 504 in a spiral direction (+) with pitch angle θ. A second reinforcement layer 530b is applied in the same spiral direction (+), at pitch angle θ′. An optional tie layer 550a may be disposed between reinforcement layer 530a and reinforcement layer 530b. Third reinforcement layer 530c is applied adjacent second reinforcement layer 530b, in the opposing spiral direction (−), at pitch angle −θ. An optional tie layer 550b may be disposed between reinforcement layer 530b and reinforcement layer 530c. A fourth reinforcement layer 530d is applied adjacent reinforcement layer 530c in the same spiral direction (−), at pitch angle −θ′, and an optional tie layer 550c may be disposed between reinforcement layer 530c and reinforcement layer 530d. Cover layer 540 is the outermost layer. Accordingly, hose 500 is provided which is of a (+) (+) (−) (−) multiple reinforcement layer spiral direction configuration.

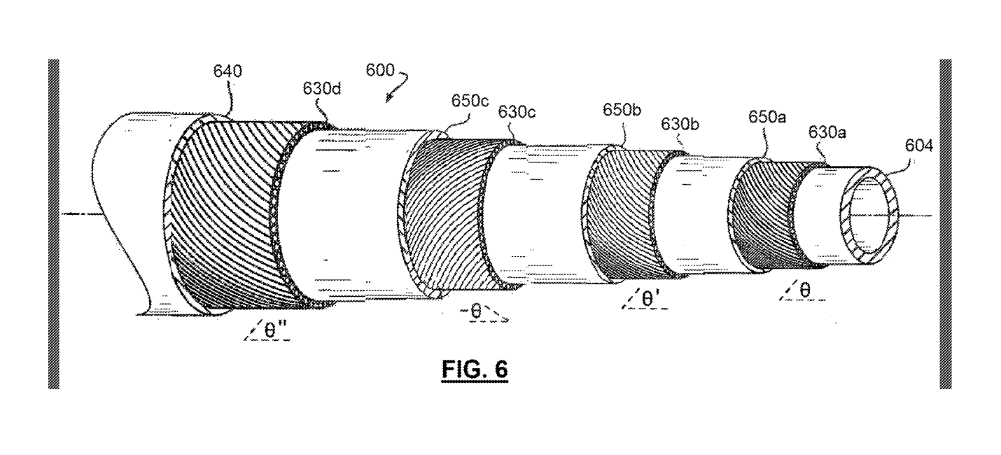

FIG. 6 depicts another hose embodiment in accordance with the disclosure. Hose 600 includes inner tube 604, first reinforcement layer 630a applied adjacent inner tube 604 in a spiral direction (+) with pitch angle θ, second reinforcement layer 630b applied in the same spiral direction (+), at pitch angle θ′, third reinforcement layer 630c applied adjacent second reinforcement layer 630b in the opposing spiral direction (−), with pitch angle −θ, and fourth reinforcement layer 630d applied adjacent reinforcement layer 630c in the opposing spiral direction (+), at pitch angle θ″. Optional tie layers 650a, 650b, and 650c may be disposed between reinforcement layers as indicated. Cover layer 640 is the outermost layer. Thus, hose 600 is provided which is of a (+) (+) (−) (+) multiple reinforcement layer spiral direction configuration.

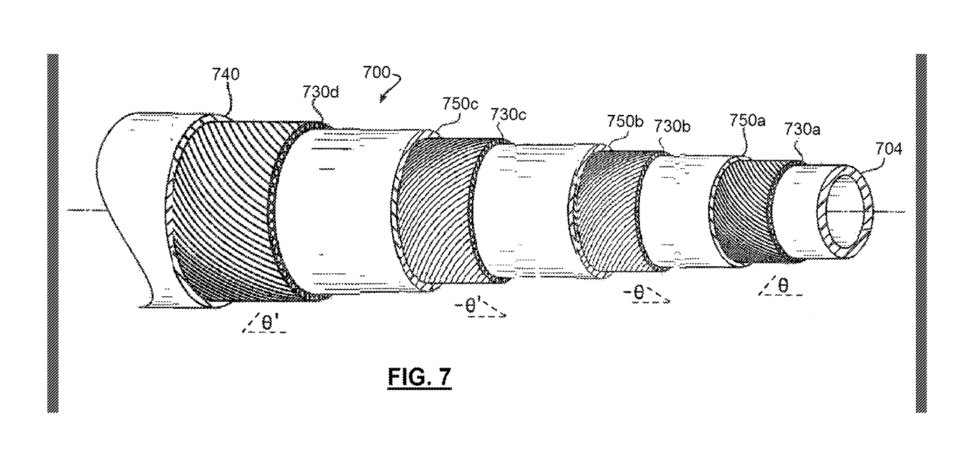

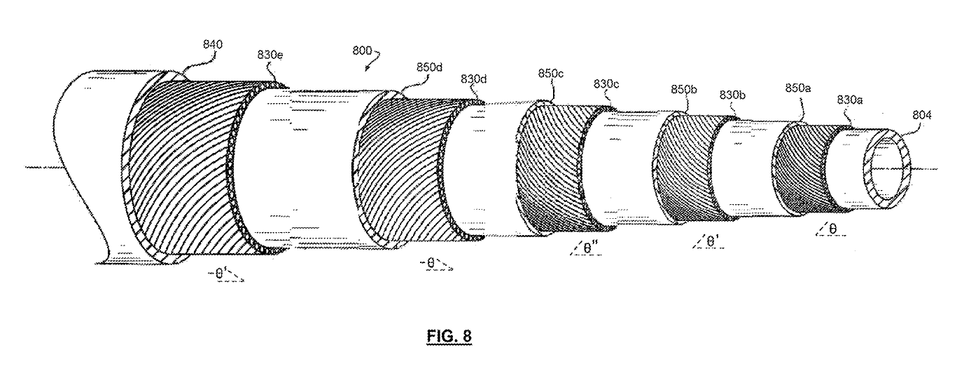

Now referencing FIG. 7, where hose 700 includes inner tube 704 and a first reinforcement layer 730a applied adjacent inner tube 704 in a spiral direction (+) with pitch angle θ. A second reinforcement layer 730b is applied in the opposing spiral direction (−), at pitch angle −θ. An optional tie layer 750a may be disposed between reinforcement layer 730a and reinforcement layer 730b. A third reinforcement layer 730c is applied adjacent second reinforcement layer 730b, and is applied in the same spiral direction (−), at pitch angle −θ′. An optional tie layer 750b may be disposed between reinforcement layer 730b and reinforcement layer 730c. Hose 700 further includes cover layer 740 as the outermost layer. A fourth reinforcement layer 730d is applied adjacent reinforcement layer 730c in the opposing spiral direction (+), at pitch angle θ′, and an optional tie layer 750c may be disposed between reinforcement layer 730c and reinforcement layer 730d. As such, hose 700 is provided which is of a (+) (−) (−) (+) multiple reinforcement layer spiral direction configuration.

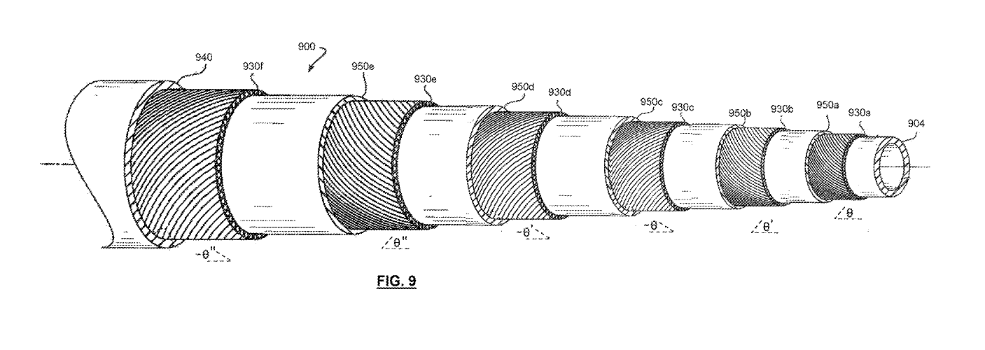

FIG. 8 depicts yet another hose embodiment in accordance with the disclosure. Hose 800 includes inner tube 804, first reinforcement layer 830a applied adjacent inner tube 804 in a spiral direction (+) with pitch angle θ, second reinforcement layer 830b applied in the same spiral direction (+), at pitch angle θ′, third reinforcement layer 830c applied adjacent second reinforcement layer 830b in the same spiral direction (+), with pitch angle θ″, fourth reinforcement layer 830d applied adjacent reinforcement layer 830c in the opposing spiral direction (−), at pitch angle −θ, and fifth reinforcement layer 830e applied adjacent reinforcement layer 830d in the same spiral direction (−), at pitch angle −θ′. Optional tie layers 850a, 850b, 850c and 850d may be disposed between reinforcement layers as indicated. Cover layer 840 is the outermost layer. Thus, hose 800 is provided which is of a (+) (+) (+) (−) (−) multiple reinforcement layer spiral direction configuration. In such a hose design, the first three reinforcement layers, 830a, 830b, 830c, are applied in the same direction, and the two outer reinforcement layers 830d, 830e, applied in the opposing spiral direction. The two outer reinforcement layers 830d, 830e, may formed of larger diameter wire/filaments, thus providing combined equal tensile strength as the first three reinforcement layers 830a, 830b, 830c. Such a configuration may have equal performance to a six reinforcement layer hose.

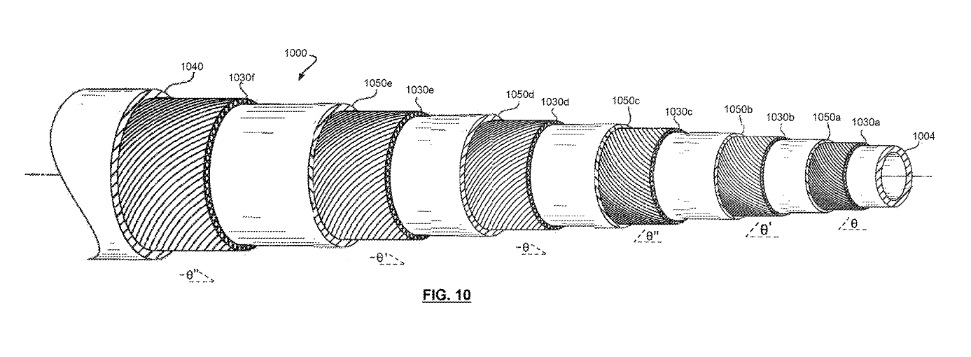

With reference to FIG. 9, which depicts another hose embodiment according to the disclosure. Hose 900 includes inner tube 904 and a first reinforcement layer 930a applied adjacent inner tube 904 in a spiral direction (+) with pitch angle θ. A second reinforcement layer 930b is applied in the same spiral direction (+), at pitch angle θ′. An optional tie layer 950a may be disposed between reinforcement layer 930a and reinforcement layer 930b. Third reinforcement layer 930c is applied adjacent second reinforcement layer 930b, in the opposing spiral direction (−), at pitch angle −θ. An optional tie layer 950b may be disposed between reinforcement layer 930b and reinforcement layer 930c. A fourth reinforcement layer 930d is applied adjacent reinforcement layer 930c in the same spiral direction (−), at pitch angle −θ′, and an optional tie layer 950c may be disposed between reinforcement layer 930c and reinforcement layer 930d. A fifth reinforcement layer 930e is applied adjacent reinforcement layer 930d in the opposing spiral direction (+), at pitch angle θ″, and an optional tie layer 950d may be disposed between reinforcement layer 930d and reinforcement layer 930e. A sixth reinforcement layer 930f is applied adjacent reinforcement layer 930e in the opposing spiral direction (−), at pitch angle −θ″, and an optional tie layer 950e may be disposed between reinforcement layer 930e and reinforcement layer 930f. Cover layer 940 is the outermost layer. Accordingly, hose 900 is provided which is of a (+) (+) (−) (−) (+) (−) multiple reinforcement layer spiral direction configuration.

FIG. 10 depicts yet another hose embodiment in accordance with the disclosure. Hose 1000 includes inner tube 1004, first reinforcement layer 1030a applied adjacent inner tube 1004 in a spiral direction (+) with pitch angle θ, second reinforcement layer 1030b applied in the same spiral direction (+), at pitch angle θ′, third reinforcement layer 1030c applied adjacent second reinforcement layer 1030b in the same spiral direction (+), with pitch angle θ″, fourth reinforcement layer 1030d applied adjacent reinforcement layer 1030c in the opposing spiral direction (−), at pitch angle −θ, fifth reinforcement layer 1030e applied adjacent reinforcement layer 830d in the same spiral direction (−), at pitch angle −θ′, and sixth reinforcement layer 1030f applied adjacent reinforcement layer 1030e in the same spiral direction (−), at pitch angle −θ″. Optional tie layers 1050a, 1050b, 1050c, 1050d and 1050e may be disposed between reinforcement layers as indicated. Cover layer 1040 is the outermost layer. Thus, hose 1000 is provided which is of a (+) (+) (+) (−) (−) (−) multiple reinforcement layer spiral direction configuration.

The hose embodiments shown in FIGS. 3 through 10 are not limiting, and a merely illustrative in scope as to some reinforcement layer spiral direction configurations. Any possible reinforcement layer spiral direction configurations may be used in accordance with the disclosure as long as at least two adjacent reinforcement layers have the same spiral direction configuration, notwithstanding the respective pitch angles of such reinforcement layers.

Inner tubes used in hose embodiments according to the disclosure may be provided as extruded or otherwise formed of a vulcanizable, chemically-resistant, synthetic rubber. As used herein, “chemical resistance” should be understood to mean the ability to resist swelling, crazing, stress cracking, corrosion, or otherwise to withstand attack from organic solvents and hydrocarbons, such as hydraulic fluids. Suitable materials include acrylonitrile butadiene rubbers (NBR) and modified NBR's such as hydrogenated NBR (HNBR) and cross-linked NBR (XNBR), as well as copolymers and blends, thereof. Such blends may be, for example, XNBR or HNBR blended with one or more of a chlorinated polyethylene (CPE), polyvinyl chloride (PVC), or polychloroprene (CR).

In its raw, i.e., uncompounded, form, the NBR may have a mid to high acrylonitrile (ACN) content of between about 19-36%, and a Mooney viscosity ((ML 1+4)@212° F. (100° C.)) of at least about 90. Such viscosity allows the rubber material to be compounded with between about 15-66% by total weight of the compound of one or more reinforcing fillers. Each of such fillers may be provided, independently, as a powder or as flakes, fibers, or other particulate form, or as a mixture of such forms. Typical of such reinforcing fillers include carbon blacks, clays, and pulp fibers. For powders, the mean average particle size of the filler, which may be a diameter, imputed diameter, screen, mesh, length, or other dimension of the particulate, may range between about 10-500 nm.

Additional fillers and additives may be included in the formulation of the rubber compound depending upon the requirements of the particular application envisioned. Such fillers and additives, which may be functional or inert, may include curing agents or systems, wetting agents or surfactants, plasticizers, processing oils, pigments, dispersants, dyes, and other colorants, opacifying agents, foaming or anti-foaming agents, anti-static agents, coupling agents such as titanates, chain extending oils, tackifiers, flow modifiers, pigments, lubricants, silanes, and other agents, stabilizers, emulsifiers, antioxidants, thickeners, and/or flame retardants. The formulation of the material may be compounded in a conventional mixing apparatus as an admixture of the rubber and filler components, and any additional fillers or additives. As vulcanized and filled with between about 15-66% of a carbon black filler.

The tension and area coverage at which the reinforcement layers are braided, wound, or knitted may be varied to achieve the desired flexibility, which may be measured by bend radius, flexural forces, or the like, of the hose embodiments.

In the illustrated constructions which may be particularly adapted for high pressure hydraulic applications, each of the reinforcement layers may be spiral wound from one end of a monofilament carbon or stainless steel wire having a generally circular cross-section with a diameter of between about 0.008-0.04 inch (0.2-1 mm). As so formed, each of the reinforcement layers thus may have a thickness of that of the wire diameter. Although a circular wire is shown, a “flat-wire” construction alternatively may be employed using wires having a rectangular, square, or other polygonal cross-section. Low profile oval or elliptical wires also may be used. To better control the elongation and contraction of the hose embodiments, and for improved impulse fatigue life, the innermost reinforcement layer may be bonded, by means of fusion, i.e., vulcanization of the inner tube, mechanical, chemical, or adhesive bonding, or a combination thereof or otherwise, to the outer surface of the inner tube. In some aspects, such bonding is achieved with a tie layer disposed between the innermost reinforcement layer and outer surface of the inner tube.

In those embodiments where tie layer is disposed between the innermost reinforcement layer and outer surface of the inner tube, the tie layer may be formed of one or more bonding resins which is to be provided between the reinforcement layer and outer surface to effect a bond across the entirety of these layers. Representative examples of such resins include Ricobond® 1756 for peroxide cured compounds and Ricobond® 1731 for sulfur cured compounds.

In some aspects, the coaxially-surrounding protective cover or jacket used in hose embodiments according to the disclosure, may be a thick layer of a fiber, glass, ceramic, or metal-filled, or unfilled, abrasion-resistant thermoplastic, i.e., melt-processible, or thermosetting, vulcanizable natural rubber or a synthetic rubber such as fluoropolymer, chlorosulfonate, polybutadiene, butyl, neoprene, nitrile, polyisoprene, and buna-N, copolymer rubbers such as ethylene-propylene (EPR), ethylene-propylene-diene monomer (EPDM), nitrile-butadiene (NBR) and styrene-butadiene (SBR), or blends such as ethylene or propylene-EPDM, EPR, or NBR, and copolymers and blends of any of the foregoing. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation. By “abrasion-resistant,” it is meant that such material for forming the cover may have a hardness of between about 60-98 Shore A durometer.

Any of the materials forming the cover layers in hose embodiments according to the disclosure may be loaded with metal particles, carbon black, or another electrically-conductive particulate, flake, or fiber filler so as to render the hoses electrically-conductive for static dissipation or other applications. Separate electrically-conductive fiber or resin layers (not shown), which may be in the form of spiral or “cigarette-wrapped” tapes or otherwise provided, also may be included in the hose constructions between the inner tube and the innermost reinforcement layer, between the reinforcement layers, or between the outermost reinforcement layer and cover.

Similar to the bonding of an inner tube to the innermost reinforcement layer, or to a textile or other layer there between, the interior surface of a cover layer may be bonded to the outermost reinforcement layer. Such bond, again, may be by fusion, chemical, mechanical, or adhesive means, or a combination thereof or other means.

Thus, illustrative rubber hose constructions are described which are of compact designs, and which are very flexible. Such constructions may be rated, such as under SAE J517 or J1754, ISO 3862 or J1745, and/or DIN EN 856, or otherwise adapted for use in a variety applications such as mobile or industrial hydraulic installations specifying relatively high working pressures of between about 4000-8000 psi (28-55 MPa), or otherwise for a variety of pneumatic, vacuum, shop air, general industrial, maintenance, and automotive applications such as for air, oil, antifreeze, and fuel. These designs could also be used in high pressure oil drilling applications such as chock and kill hose or rotary drilling hose. They also could be used in high pressure compact braided hydraulic hose.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A hose comprising:
an inner tube defining a central longitudinal axis there through, and comprising a vulcanized rubber, wherein the inner tube has a tube wall thickness (t) of between about 0.5 mm to about 1.5 mm;
a first reinforcement layer applied adjacent inner tube in a spiral direction (+) at pitch angle θ, and a second reinforcement layer applied in the same spiral direction (+) at pitch angle θ′;
a third reinforcement layer applied adjacent the second reinforcement layer, the third reinforcement layer applied in an opposing spiral direction (−) at pitch angle −θ; and,
a cover disposed outward from the third reinforcement layer.

2. The hose according to claim 1, wherein the hose has a wall thickness (T), and the tube wall thickness (t) comprises less than about 25% of the hose wall thickness.

3. The hose according to claim 1, wherein the vulcanized rubber comprises an acrylonitrile butadiene rubber (NBR), a hydrogenated NBR (HNBR), a cross-linked NBR (XNBR), or copolymers and blends thereof.

4. The hose according to claim 1, wherein the inner tube comprises a plurality of rod shaped particles orientated substantially parallel with the central longitudinal axis, and wherein the plurality of rod shaped particles is incorporated in an amount of 10% or less by weight, based upon total weight of the inner tube.

5. The hose according to claim 4, wherein the plurality of rod shaped particles is incorporated in an amount of from 1% to 7% by weight, based upon total weight of the inner tube.

6. The hose according to claim 1, wherein the rubber has a modulus of at about 12 MPa and a tensile strength of at least about 18 MPa.

7. The hose according to claim 1, wherein a tie layer is disposed between the first reinforcement layer and the second reinforcement layer.

8. The hose according to claim 1, wherein a tie layer is disposed between the second reinforcement layer and the third reinforcement layer.

9. The hose according to claim 1 further comprising a fourth reinforcement layer applied adjacent third reinforcement layer, the fourth reinforcement layer applied in an opposing spiral direction (−), at pitch angle −θ′.

10. The hose according to claim 1, further comprising a plurality of reinforcement layers.

11. The hose comprising an inner tube, a cover, and at least three reinforcement layers applied between the inner tube and the cover, wherein two immediately adjacent reinforcement layers of the at least three reinforcement layers are applied in same spiral directions (+) (+), and wherein another reinforcement layer of the at least three reinforcement layers is applied in an opposing spiral direction (−).

12. The hose according to claim 11, wherein the inner tube has a tube wall thickness (t) of between about 0.5 mm to about 1.5 mm, wherein the hose has a wall thickness (T), and wherein the tube wall thickness (t) comprises less than about 25% of the hose wall thickness.

13. The hose according to claim 11, wherein tie layers are disposed between the at least three reinforcement layers.

14. The hose according to claim 11, wherein the inner tube comprises a plurality of rod shaped particles orientated substantially parallel with the central longitudinal axis, and wherein the plurality of rod shaped particles is incorporated in an amount of 10% or less by weight, based upon total weight of the inner tube.

15. A hose comprising:
an inner tube defining a central longitudinal axis there through, and comprising a vulcanized rubber;
a first reinforcement layer applied adjacent inner tube in a spiral direction (+) at pitch angle θ, a second reinforcement layer applied in the same spiral direction (+) at pitch angle θ′, and a third reinforcement layer applied in the same spiral direction (+) at pitch angle θ″;
a fourth reinforcement layer applied in an opposing spiral direction (−) at pitch angle −θ, and a fifth reinforcement layer applied in the spiral direction (−) at pitch angle −θ′; and,
a cover disposed outward from the fifth reinforcement layer.

16. The hose according to claim 15, wherein tie layers are disposed between the first reinforcement layer and the second reinforcement layer, between the second reinforcement layer and the third reinforcement layer, between the third reinforcement layer and the fourth reinforcement layer, and/or between the fourth reinforcement layer and the fifth reinforcement layer.

17. The hose according to claim 15, wherein the inner tube has a tube wall thickness (t) of between about 0.5 mm to about 1.5 mm.

18. The hose according to claim 17, wherein the hose has a wall thickness (T), and the tube wall thickness (t) comprises less than about 25% of the hose wall thickness.

19. The hose according to claim 15, wherein the inner tube comprises a plurality of rod shaped particles orientated substantially parallel with the central longitudinal axis, and wherein the plurality of rod shaped particles is incorporated in an amount of 10% or less by weight, based upon total weight of the inner tube.

20. The hose according to claim 15, wherein the fourth reinforcement layer and the fifth reinforcement layer have a combined tensile strength substantially equal to a combined tensile strength of the first reinforcement layer, the second reinforcement layer and the third reinforcement layer.
